(19) United States
(12) Patent Application Publication
(10) Pub. No.: US 2010/0106830 A1
(43) Pub. Date: Apr. 29, 2010

(54) METHOD AND APPARATUS FOR COLLECTING AND DELIVERING STATISTICAL DATA

(75) Inventors: Masaaki Takase, Kawasaki (JP); Mitsuyasu Ogawa, Kawasaki (JP); Makoto Kanazawa, Kawasaki (JP); Kenichi Fukuda, Kawasaki (JP); Masafumi Katoh, Kawasaki (JP); Jun Maeda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/648,730

(22) Filed: Dec. 29, 2009

Related U.S. Application Data
(63) Continuation of application No. PCT/JP2007/063851, filed on Jul. 11, 2007.

(51) Int. Cl. G06F 15/16

(52) U.S. Cl. 709/224

(57) ABSTRACT

A statistical-data collecting-and-providing apparatus receives, through a statistical-data-acquisition-criterion setting interface, setting of a statistical-data acquisition criterion and setting of a notification destination, which is a destination of statistical data delivery. Subsequently, the statistical-data collecting-and-providing apparatus collects statistical data based on the thus-received statistical-data acquisition criterion. Thereafter, the statistical-data collecting-and-providing apparatus delivers the thus-collected statistical data to a service-providing application server, which is the notification destination received through the statistical-data-acquisition-criterion setting interface.

### CROSS-REFERENCE TO RELATED APPLICATION(S)

This application is a continuation of International Application No. PCT/JP2007/063851, filed on Jul. 11, 2007, the entire contents of which are incorporated herein by reference.

### FIELD

The embodiments discussed herein are generally directed to a statistical-data collecting-and-delivery apparatus and a statistical-data collecting-and-delivery method.

### BACKGROUND

Platforms (e.g., service delivery platform (SDP)) aiming at quick development of service or reducing cost involved in development and management of service have been proposed in recent years.

Examples of services developed by using such a platform include a service that collects statistical data and utilizes the collected data. Examples of a method applicable to the statistical data collection include a method of adding an application program interface (API) to an operation system for each service to be executed and collecting statistical data based on the added API so that the service is executed by making use of the statistical data.

Known example methods for collecting statistical data include a technique of collecting statistical data from a plurality of terminals that contain personal data (see Japanese Laid-open Patent Publication No. 2006-113851), a technique of efficiently collecting data by exchanging survey data with a survey subject (see Japanese Laid-open Patent Publication No. 2004-303090), a technique of collecting statistical data pertaining to access from a plurality of users (see Japanese Laid-open Patent Publication No. 2002-24127), and a technique of accumulating statistical data of various formats only through updating of analysis control data (see Japanese Laid-open Patent Publication No. 11-175373).

However, the conventional technique of adding APIs to an operation system is disadvantageous in that it is necessary to modify the operation system on service-by-service basis, which requires considerable operation management cost.

The techniques disclosed in Japanese Laid-open Patent Publication No. 2006-113851, Japanese Laid-open Patent Publication No. 2004-303090, Japanese Laid-open Patent Publication No. 2002-24127, and Japanese Laid-open Patent Publication No. 11-175373 are disadvantageous in giving no consideration to notification destinations of collected statistical data and hence being unable to perform delivery to a specific notification destination by a specific criterion. This causes the notification destination to receive statistical data that contains data unnecessary for the notification destination, which increases load on the notification destination.

### SUMMARY

According to an aspect of an embodiment of the invention, a statistical-data collecting-and-delivery apparatus is for collecting statistical data relating to communications and delivering the statistical data. The statistical-data collecting-and-delivery apparatus includes a statistical-data-acquisition-setting receiving unit that receives setting of a statistical-data acquisition criterion and setting of a notification destination which is a destination of statistical data delivery; a statistical-data collecting unit that collects the statistical data based on the statistical-data acquisition criterion received by the statistical-data-acquisition-setting receiving unit; and a statistical-data delivering unit that delivers the statistical data collected by the statistical-data collecting unit to the notification destination received by the statistical-data-acquisition-setting receiving unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating overview and features of a statistical-data collecting-and-providing apparatus according to a first embodiment;

FIG. 2 is a block diagram illustrating an example network configuration, to which the statistical-data collecting-and-providing apparatus according to the first embodiment is applicable;

FIG. 3 is a block diagram illustrating the configuration of the statistical-data collecting-and-providing apparatus according to the first embodiment;

FIG. 4 is a schematic diagram illustrating an example statistical-data-acquisition-criterion setting interface;

FIG. 5 is a schematic diagram illustrating a specific example setting of the statistical-data-acquisition-criterion setting interface;

FIG. 6 is a schematic diagram illustrating an example statistical-data-delivery-criterion setting message;

FIG. 7 is a schematic diagram illustrating data stored in an application-management storage unit;

FIG. 8 is a schematic diagram illustrating statistical-data collection criteria stored in a statistical-data storage unit;

FIG. 9 is a schematic diagram illustrating statistical data stored in the statistical-data storage unit;

FIG. 10 is a schematic diagram illustrating detailed statistical data stored in the statistical-data storage unit;

FIG. 11 is a schematic diagram illustrating an example notification message;

FIG. 12 is a schematic diagram illustrating another example notification message;

FIG. 13 is a schematic diagram illustrating another example notification message;

FIG. 14 is a schematic diagram illustrating another example notification message;

FIG. 15 is a sequence diagram illustrating a collection-criteria setting process to be performed by the statistical-data collecting-and-providing apparatus according to the first embodiment;

FIG. 16 is a schematic diagram illustrating an example profile-update requesting message transmitted from the statistical-data collecting-and-providing apparatus to a subscriber management server;

FIG. 17 is a schematic diagram illustrating an example profile-update requesting message transmitted from the subscriber management server to a Serving-Call Session Control Function (S-CSCF);

FIG. 18 is a schematic diagram illustrating an example of a content registered in the S-CSCF;

FIG. 19 is a sequence diagram illustrating a statistical-data collecting process to be performed by the statistical-data collecting-and-providing apparatus according to the first embodiment;

FIG. 20 is a sequence diagram illustrating a statistical-data collecting-and-providing-process to be performed by the statistical-data collecting-and-providing apparatus according to the first embodiment; and

FIG. 21 is a schematic diagram illustrating a computer that executes a statistical-data collecting-and-providing computer program.

### DESCRIPTION OF EMBODIMENTS

Preferred embodiments of the present invention will be explained with reference to accompanying drawings.

### [a] First Embodiment

In the embodiments discussed below, overview and features of a statistical-data collecting-and-providing apparatus 10 according to a first embodiment of the present invention are discussed, which are followed by description about the configuration and process procedure of the statistical-data collecting-and-providing apparatus 10, and effect of the first embodiment is discussed at the end.

Overview and Features of Statistical-Data Collecting-and-Providing Apparatus 10 According to First Embodiment

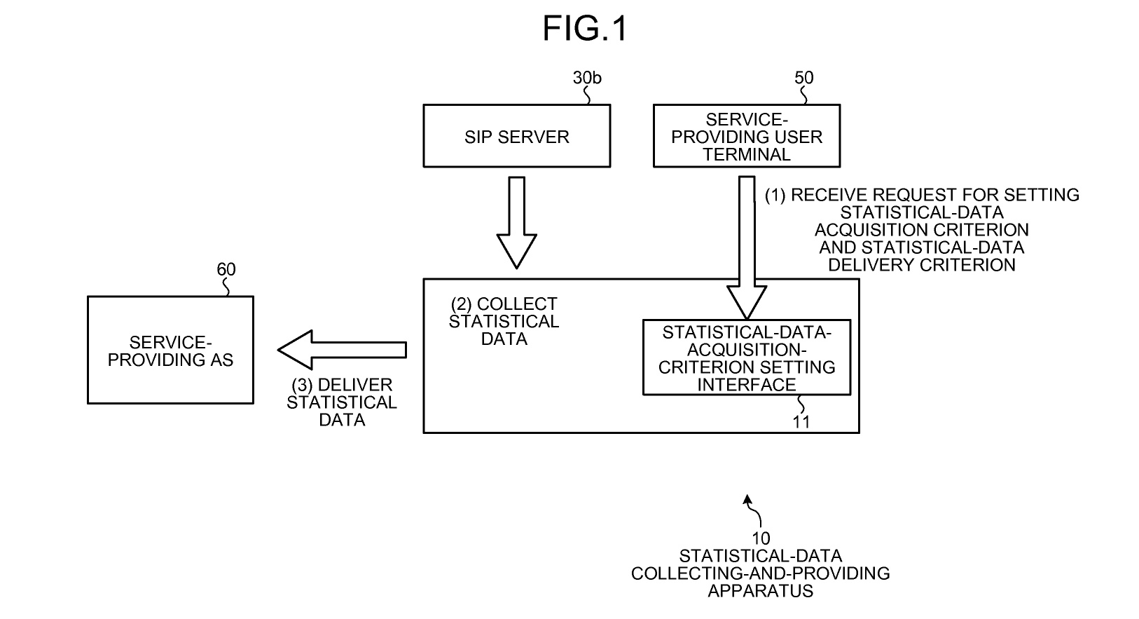

Overview and features of the statistical-data collecting-and-providing apparatus 10 according to the first embodiment will be described with reference to FIG. 1. FIG. 1 is a schematic diagram illustrating the overview and features of the statistical-data collecting-and-providing apparatus 10 according to the first embodiment.

Briefly described, the statistical-data collecting-and-providing apparatus 10 according to the first embodiment collects statistical data relating to communications and provides the statistical data to a service-providing application server 60. A main feature of the statistical-data collecting-and-providing apparatus 10 is that load placed the application server 60, which is a notification destination of the statistical data, and operation management cost involved in service delivery are reduced.

This main feature will be specifically discussed below. The statistical-data collecting-and-providing apparatus 10 according to the first embodiment is connected to, as illustrated in FIG. 1, a Session Initiation Protocol (SIP) server 30b that processes a message (message for use in call control), which can be statistical data, and forwards the message to the statistical-data collecting-and-providing apparatus 10, a service-providing user terminal 50 that manages the service-providing application server 60 that provides service, and the service-providing application server 60 that provides the service by making use of the statistical data.

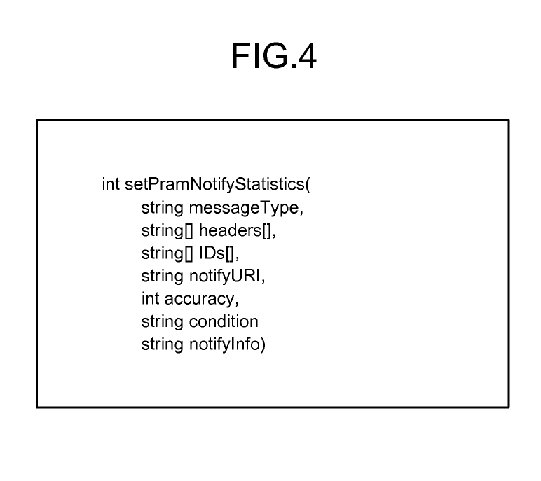

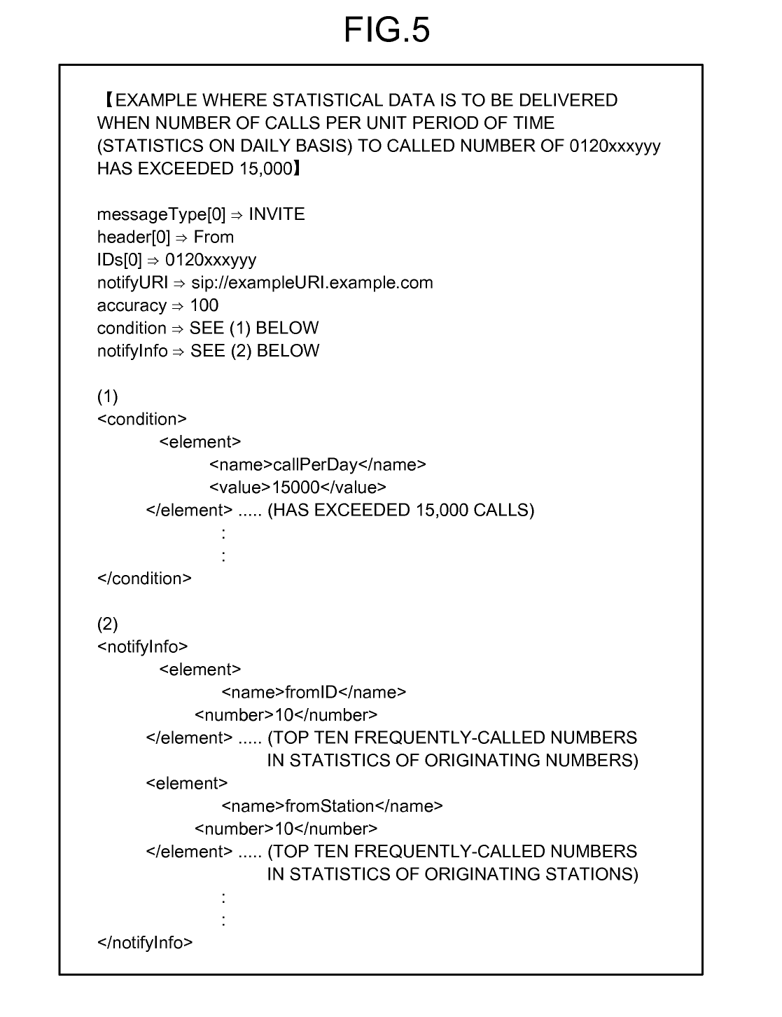

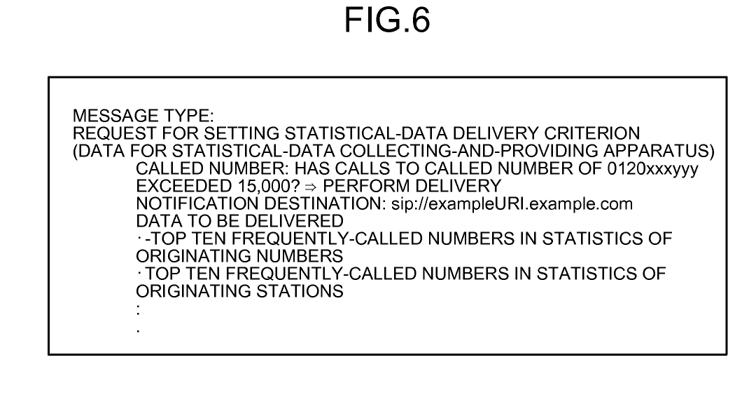

The statistical-data collecting-and-providing apparatus 10 having such a configuration receives setting of a statistical-data acquisition criterion for acquisition of statistical data and setting of a notification destination, to which the statistical data is to be delivered, through a statistical-data-acquisition-criterion setting interface 11 (see (1) of FIG. 1). Specifically, the statistical-data collecting-and-providing apparatus 10 receives, from the service-providing user terminal 50, a statistical-data-collection-criterion setting message, which is a statistical-data collection criterion, and the statistical-data-collection-criterion setting message (to be described later in detail with reference to FIG. 4, FIG. 5, and FIG. 6) that contains a notification destination and a criterion for delivering the statistical data to the service-providing application server 60.

Subsequently, the statistical-data collecting-and-providing apparatus 10 collects statistical data based on the thus-received statistical-data acquisition criterion (see (2) of FIG. 1). Specifically, the statistical-data collecting-and-providing apparatus 10 analyzes a message forwarded from the SIP server 30b and counts items that satisfy the statistical-data collection criterion as statistical data. Put another way, the statistical-data collecting-and-providing apparatus 10 collects only statistical data specified by the service-providing user terminal 50 and delivers only the required data to the application server 60, thereby reducing load on the application server 60.

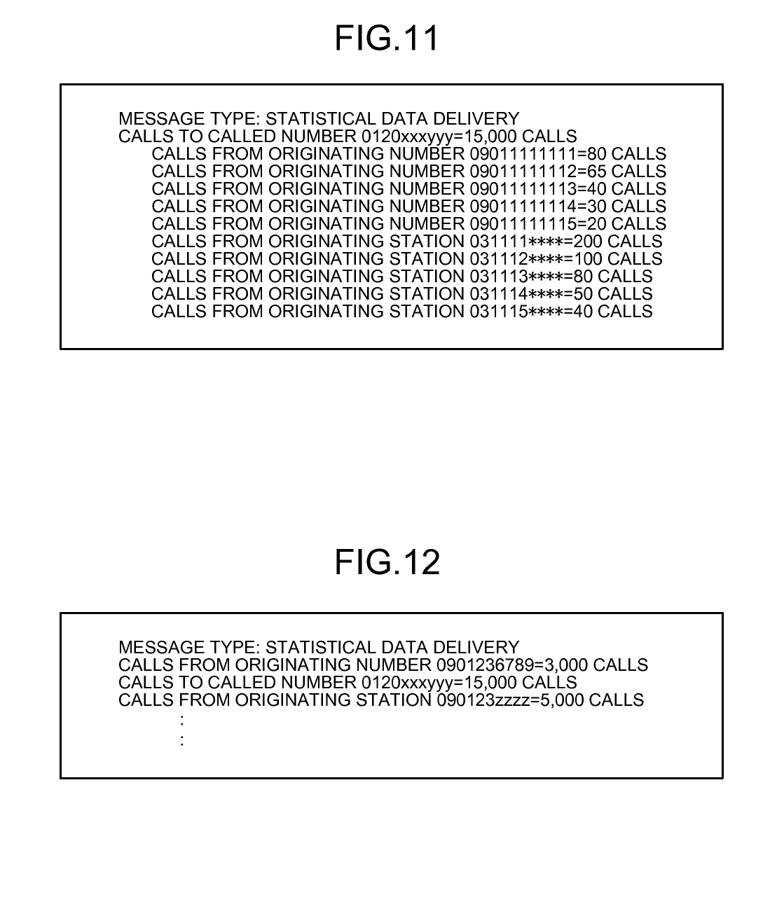

Thereafter, the statistical-data collecting-and-providing apparatus 10 delivers the collected statistical data to the service-providing application server 60, which is the notification destination received through the statistical-data-acquisition-criterion setting interface 11 (see (3) of FIG. 1). Specifically, when the statistical-data delivery criterion is satisfied, the statistical-data collecting-and-providing apparatus 10 transmits a notification message (FIG. 11 to FIG. 14) that contains the statistical data to the application server 60, which is the notification destination.

The statistical-data collecting-and-providing apparatus 10 thus delivers to a notification destination only data that is necessary for the notification destination only by making settings rather than modifying an operation system, thereby allowing reduction in load on the notification destination and operation management cost involved in service delivery as discussed above as the main feature.

Network Configuration

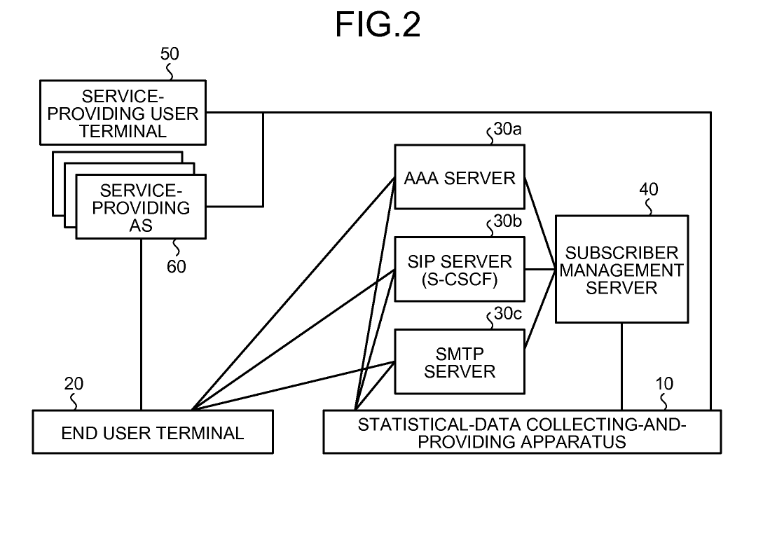

An example network configuration, to which the statistical-data collecting-and-providing apparatus 10 illustrated in FIG. 1 is applicable, will be described with reference to FIG. 2. FIG. 2 is a block diagram illustrating the example network configuration, to which the statistical-data collecting-and-providing apparatus 10 according to the first embodiment is applicable.

As illustrated in FIG. 2, the network, to which the statistical-data collecting-and-providing apparatus 10 according to the first embodiment is applied, includes the statistical-data collecting-and-providing apparatus 10, an authentication, authorization, and accounting (AAA) server 30a that processes a message that can be statistical data, the SIP server 30b and a simple mail transfer protocol (SMTP) server 30c (hereinafter, referred to as “SIP server 30b and the like”), a plurality of the application servers 60 (hereinafter, referred to as “service-providing AS 60”) that individually provide services, an end user terminal 20 (an originating subscriber terminal, a called subscriber terminal, or a serviced terminal on called side), the service-providing user terminal 50 that manages the service-providing application server 60 that provides service, and a subscriber management server 40 that manages service subscribers.

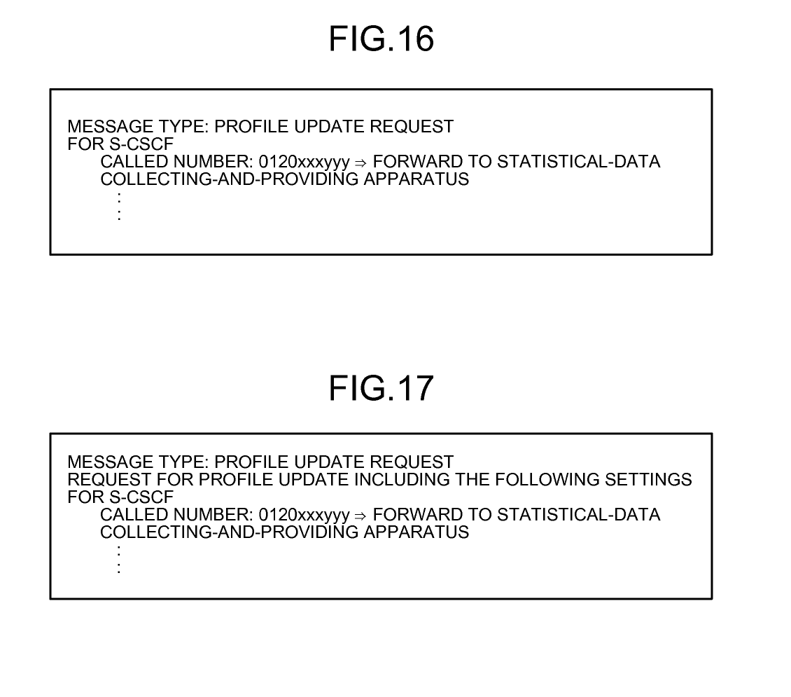

The statistical-data collecting-and-providing apparatus 10 is connected to the SIP server 30b and the like, the subscriber management server 40, the service-providing user terminal 50, and the service-providing AS 60 to exchange various data therewith. Specifically, the statistical-data collecting-and-providing apparatus 10 receives, from the service-providing user terminal 50, a statistical-data-collection-criterion setting message, corresponding to criteria for collecting and providing statistical data, and a statistical-data-delivery-criterion setting message (to be described later in detail with reference to FIG. 4, FIG. 5, and FIG. 6) and transmits a profile-update requesting message (see FIG. 16) to the subscriber management server 40 to change a user profile on the subscriber management server 40.

The statistical-data collecting-and-providing apparatus 10 receives a message forwarded from the S-CSCF 30b and the like and, if it is necessary (for example, in a case of call forwarding service for “0120” in Japan), forwards the message to the service-providing AS 60. The service-providing AS 60 creates a new message and transmits the message to the data collecting-and-providing apparatus 10. The statistical-data collecting-and-providing apparatus 10 also delivers a notification message (see FIG. 11 to FIG. 14) that contains statistical data to the service-providing AS 60.

The SIP server and the like 30b is connected to the statistical-data collecting-and-providing apparatus 10, the end user terminal 20, and the subscriber management server 40 and receives a message instructing to perform service registration (see FIG. 17) from the subscriber management server 40. When an ordinary call is originated by the end user terminal 20 (originating subscriber terminal), the SIP server and the like 30b detects that this call matches a service registration criterion and forwards the call to the data collecting-and-providing apparatus 10.

The subscriber management server 40 is connected to the statistical-data collecting-and-providing apparatus 10 and the S-CSCF 30b and the like and receives a criterion setting message from the statistical-data collecting-and-providing apparatus 10 to change a profile of a target user on the subscriber management server 40. The subscriber management server 40 updates the profile of the target user and transmits a message instructing to perform service registration to a server involved (the S-CSCF 30b and the like).

The service-providing user terminal 50 is connected to the statistical-data collecting-and-providing apparatus 10 and transmits a statistical-data-collection-criterion setting message and a statistical-data-delivery-criterion setting message to the statistical-data collecting-and-providing apparatus 10 through the statistical-data-acquisition-criterion setting interface 11.

The service-providing AS 60 is connected to the statistical-data collecting-and-providing apparatus 10 and the end user terminal 20 and transmits and receives messages to and from the statistical-data collecting-and-providing apparatus 10. The service-providing AS 60 provides service by use of statistical data to the end user terminal 20 (serviced terminal on called side).

Configuration of statistical-data collecting-and-providing apparatus

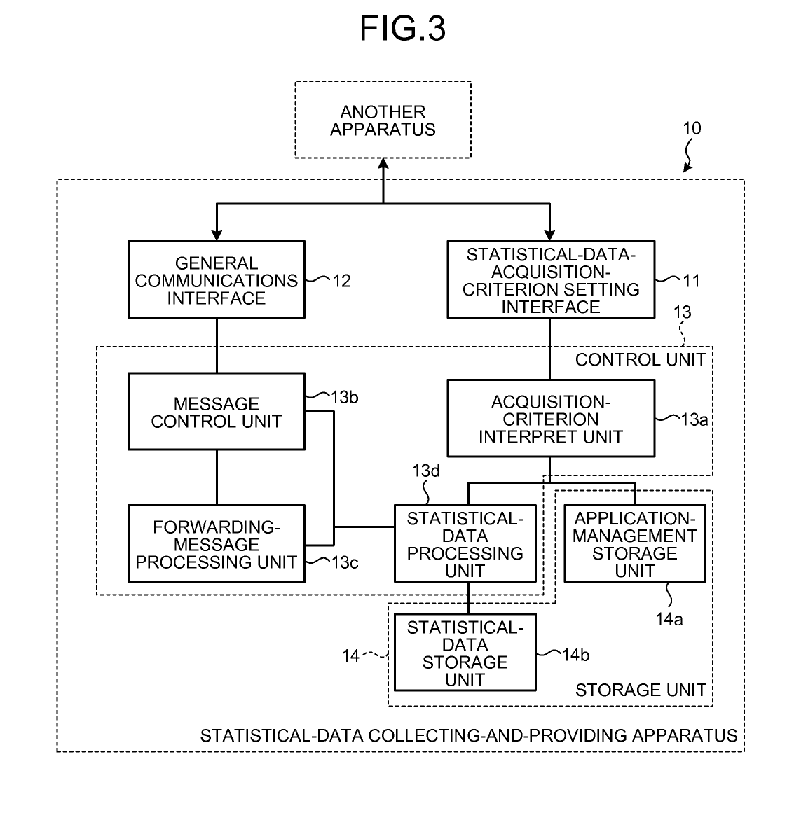

The configuration of the statistical-data collecting-and-providing apparatus 10 illustrated in FIG. 1 will be described with reference to FIG. 3. FIG. 3 is a block diagram illustrating the configuration of the statistical-data collecting-and-providing apparatus 10 according to the first embodiment. As illustrated in FIG. 3, the data collecting-and-providing apparatus 10 includes the statistical-data-acquisition-criterion setting interface 11, a general communications interface 12, a control unit 13, and a storage unit 14. Processes performed by these units will be described below.

The statistical-data-acquisition-criterion setting interface 11 receives setting of a statistical-data acquisition criterion and setting of a notification destination, to which the statistical data is to be delivered. Specifically, the statistical-data-acquisition-criterion setting interface 11 receives, from the service-providing user terminal 50, a statistical-data-collection-criterion setting message and a statistical-data-delivery-criterion setting message, which are criteria for collecting and delivering statistical data, and transmits a criteria setting message to the subscriber management server 40 to change a user profile on the subscriber management server 40. The statistical-data collecting-and-providing apparatus 10 delivers the statistical data to the service-providing AS 60. The statistical-data-acquisition-criterion setting interface 11 corresponds to the “statistical-data-acquisition-setting receiving unit” in the appended claims.

An example of the statistical-data-collection-criterion setting message and an example of the statistical-data-delivery-criterion setting message that can be set from the statistical-data-acquisition-criterion setting interface 11 will be described with reference to FIG. 4, FIG. 5, and FIG. 6. As illustrated in FIG. 4, the statistical-data-acquisition-criterion setting interface 11 receives “messageType” that is a message type to be counted as statistical data, “headers[ ]” that is a portion to be counted, “identifications (ID)s[ ]” (e.g., SIP-universal resource identifier (URI)) that is to be counted, “URI” that is a notification destination of a result of the count, “accuracy” that is count accuracy, “condition” that is a delivery criterion for a statistical data message, and “notifyInfo” that is notification content.

FIG. 5 illustrates a more specific example of a statistical-data-collection-criterion setting message of which content is set such that statistical data is to be collected when the number of calls per unit period of time (statistics on daily basis) to a called number of 0120xxxyyy has exceeded 15,000. Various electronic data exchange formats can be exchanged through the statistical-data-acquisition-criterion setting interface 11. The statistical-data-acquisition-criterion setting interface 11 can be WebService interface or the like, through which similar data is to be exchanged.

The statistical-data-acquisition-criterion setting interface 11 receives a statistical-data-delivery-criterion setting message from the service-providing user terminal 50. The statistical-data-acquisition-criterion setting interface 11 receives, as illustrated in FIG. 6, a statistical-data delivery criterion, a notification destination of the statistical data, and notification content as the statistical-data-delivery-criterion setting message.

The general communications interface 12 controls communications of general messages. Specifically, the statistical-data collecting-and-providing apparatus 10 receives a message forwarded from the S-CSCF 30b and the like and, if it is necessary (for example, in a case of call forwarding service for “0120”), forwards the message to the service-providing AS 60, causing the service-providing AS 60 to create a new message and to transmit the message to the data collecting-and-providing apparatus 10.

The storage unit 14 stores therein data and programs involved in various processes to be performed by the control unit 13 and includes, as elements that are particularly closely relating to the present invention, an application-management storage unit 14a and a statistical-data storage unit 14b.

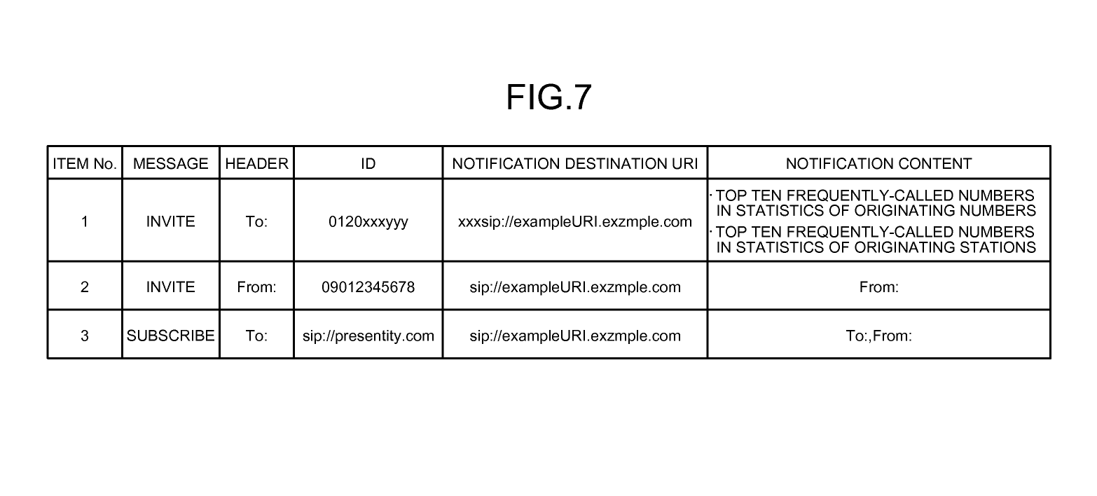

The application-management storage unit 14a stores therein a statistical-data collection criterion, by which statistical data is to be acquired, and data on delivery destination, or application software, to which the statistical data is to be delivered. Specifically, as illustrated in FIG. 7, the application-management storage unit 14a stores therein, as the statistical-data collection criterion, “message” that is a message type to be counted as statistical data, “header” that is a portion to be counted, “ID” that is to be counted, and stores therein, as data relating to delivery of the statistical data, “notification destination URI,” to which the statistical data is to be delivered, and “notification content” to be delivered to the notification destination.

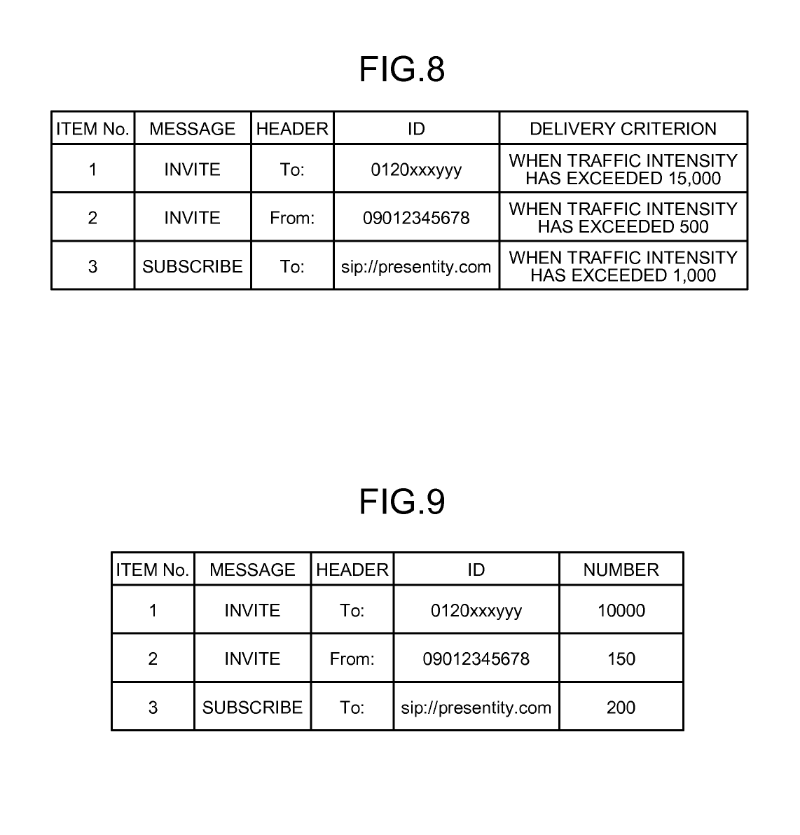

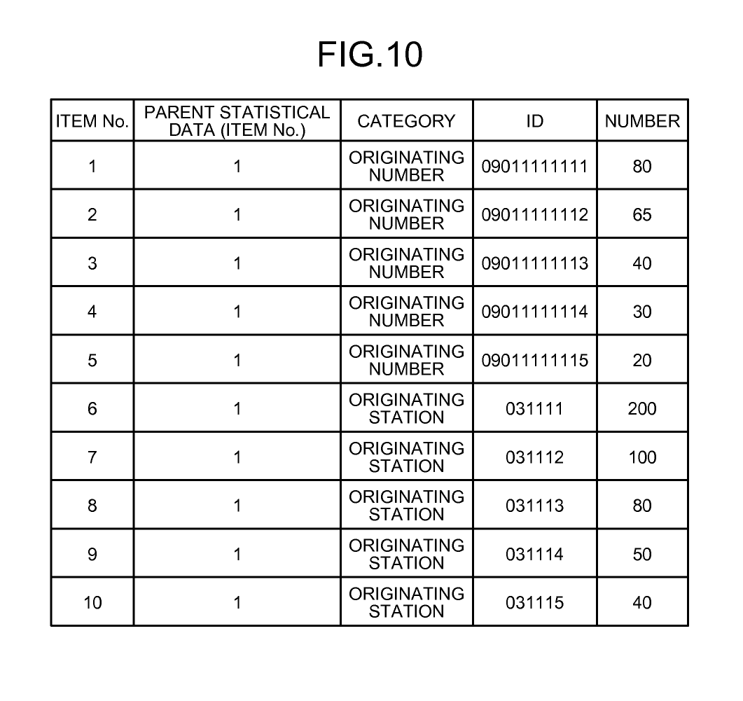

The statistical-data storage unit 14b stores therein statistical-data delivery criterion and statistical data. Specifically, as illustrated in FIG. 8, the statistical-data storage unit 14b stores therein “delivery criterion” of the statistical data together with “message,” “header,” and “ID,” which are the statistical-data collection criterion. As illustrated in FIG. 9, the statistical-data storage unit 14b stores therein the “number” counted as statistical data in addition to the statistical-data collection criterion to monitor a notification threshold value. Specifically, if the counted number has exceeded the threshold value of the “delivery criterion” given in FIG. 8, the statistical data is delivered. As illustrated in FIG. 10, the statistical-data storage unit 14b stores therein detailed data about the statistical data to create a notification message to be delivered to the S-CSCF 30b.

The control unit 13 includes internal memory to store therein programs that define various process procedures and necessary data and executes various processes by use of these programs and data. The control unit 13 includes, as elements that are particularly closely relating to the present invention, an acquisition-criterion interpret unit 13a, a message control unit 13b, a forwarding-message processing unit 13c, and a statistical-data processing unit 13d. The statistical-data processing unit 13d corresponds to the “statistical-data collecting unit” in the appended claims and the message control unit 13b corresponds to the “statistical-data delivery unit” in the appended claims.

The acquisition-criterion interpret unit 13a analyzes a statistical-data-collection-criterion setting message and a statistical-data-delivery-criterion setting message that are received. Specifically, the acquisition-criterion interpret unit 13a interprets a request for collecting statistical data fed from the service-providing AS 60, determines an item to be counted as a statistical-data collection criterion, and delivers the item to the statistical-data processing unit 13d as well as causes the application-management storage unit 14a to store therein application software of the notification destination.

The message control unit 13b creates a notification message to deliver the statistical data and performs delivery. Specifically, upon receiving the received message from the S-CSCF 30b and the like, the message control unit 13b notifies the forwarding-message processing unit 13c thereof. Upon receiving from the statistical-data processing unit 13d an instruction to transmit a notification message for delivery of the statistical data, the message control unit 13b creates a notification message by referring to the notification content and the notification destination URI stored in the application-management storage unit 14a, and delivers the message to the service-providing AS 60.

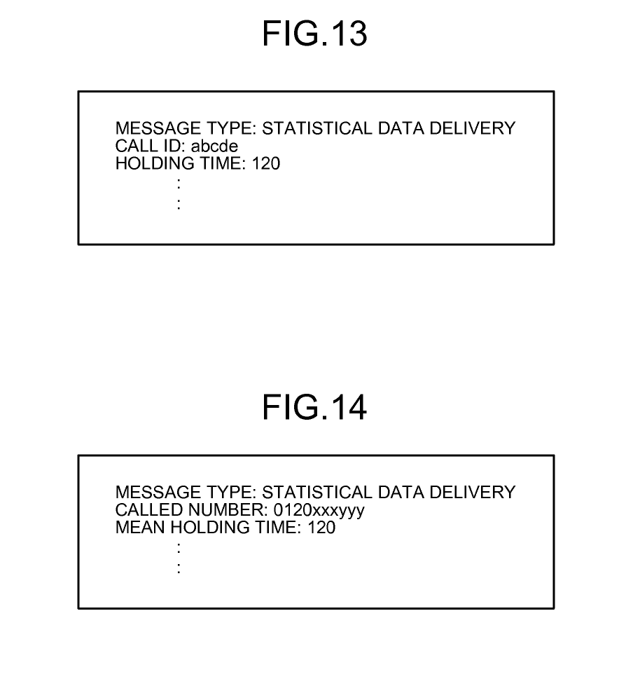

Examples of the notification message to be delivered to the service-providing AS 60 will be described with reference to FIG. 11 to FIG. 14. For example, the message control unit 13b delivers at least any one of top five frequently-called numbers in statistics of originating numbers (see FIG. 11), traffic intensity (see FIG. 12), holding time of a certain call (see FIG. 13), and average holding time of a certain called number (see FIG. 14) to the service-providing AS 60 as notification content of a notification message.

The forwarding-message processing unit 13c processes the message forwarded from the S-CSCF 30b and the like in a conventional manner. Specifically, the forwarding-message processing unit 13c makes a copy of a forwarding message delivered from the message control unit 13b and delivers the copy to the statistical-data processing unit 13d.

The statistical-data processing unit 13d delivers the collected statistical data to the service-providing AS 60 of the notification destination. Specifically, the statistical-data processing unit 13d analyzes the message delivered from the statistical-data processing unit 13d and counts items that satisfy the statistical-data collection criterion stored in the statistical-data storage unit 14b. When the statistical-data delivery criterion is satisfied, the statistical-data processing unit 13d delivers to the message control unit 13d an instruction to transmit a notification message to the service-providing AS 60.

Collection-Criteria Setting Process Performed by Statistical-Data Collecting-and-Providing Apparatus

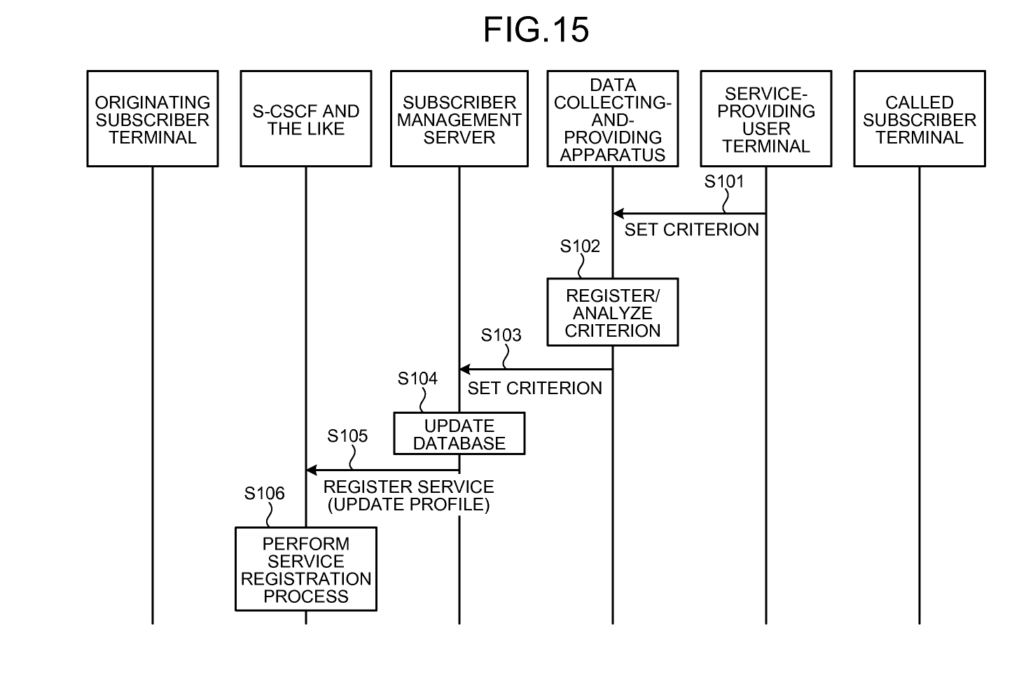

A collection-criteria setting process to be performed by the statistical-data collecting-and-providing apparatus 10 according to the first embodiment will be described with reference to FIG. 15. FIG. 15 is a sequence diagram illustrating the collection-criteria setting process to be performed by the statistical-data collecting-and-providing apparatus 10 according to the first embodiment.

As illustrated in FIG. 15, the statistical-data collecting-and-delivery apparatus 10 receives a statistical-data-collection-criterion setting message and a statistical-data-delivery-criterion setting message from the service-providing user terminal 50 (Step S101). As discussed above with reference to FIG. 4, FIG. 5, and FIG. 6, the statistical-data-collection-criterion setting message and the statistical-data-delivery-criterion setting message are messages adapted to the statistical-data-acquisition-criterion setting interface 11 exposed by the data collecting-and-providing apparatus 10.

The statistical-data collecting-and-providing apparatus 10 receives the statistical-data-collection-criterion setting message and the statistical-data-delivery-criterion setting message that are received and analyzes them (Step S102). The statistical-data collecting-and-providing apparatus 10 transmits a profile-update requesting message to the subscriber management server 40 to change a profile of a target user on the subscriber management server 40 (Step S103). For example, the statistical-data collecting-and-providing apparatus 10 transmits to the subscriber management server 40 a profile-update requesting message that requests to make setting such that, as given in FIG. 16, when a call has a called number “0120xxxyyy,” the call is forwarded to the statistical-data collecting-and-providing apparatus 10. In a case where the subscriber management server 40 is an internet protocol (IP) multimedia subsystem (IMS)-based home subscriber server (HSS), this message is handled by using DIAMETER protocol.

Subsequently, the subscriber management server 40 updates the profile of the target user (Step S104) and transmits to a server involved (the S-CSCF 30b and the like) a message (see FIG. 17) that instructs to perform service registration (Step S105).

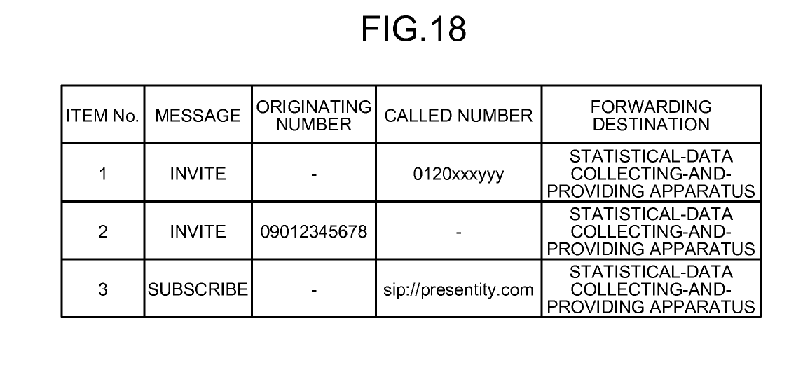

Thereafter, the S-CSCF 30b and the like perform a service registration process. For example, as illustrated in FIG. 18, the S-CSCF 30b establishes correspondence between forwarding criteria (a message type, and an originating number and a called number) and a forwarding destination, to which the message is to be forwarded when the criteria are satisfied, and registers the criteria and the forwarding destination. After this time, messages specified by the criteria are to be forwarded to the data collecting-and-providing apparatus 10.

Statistical-Data Collecting Process Performed by Statistical-Data Collecting-and-Providing Apparatus

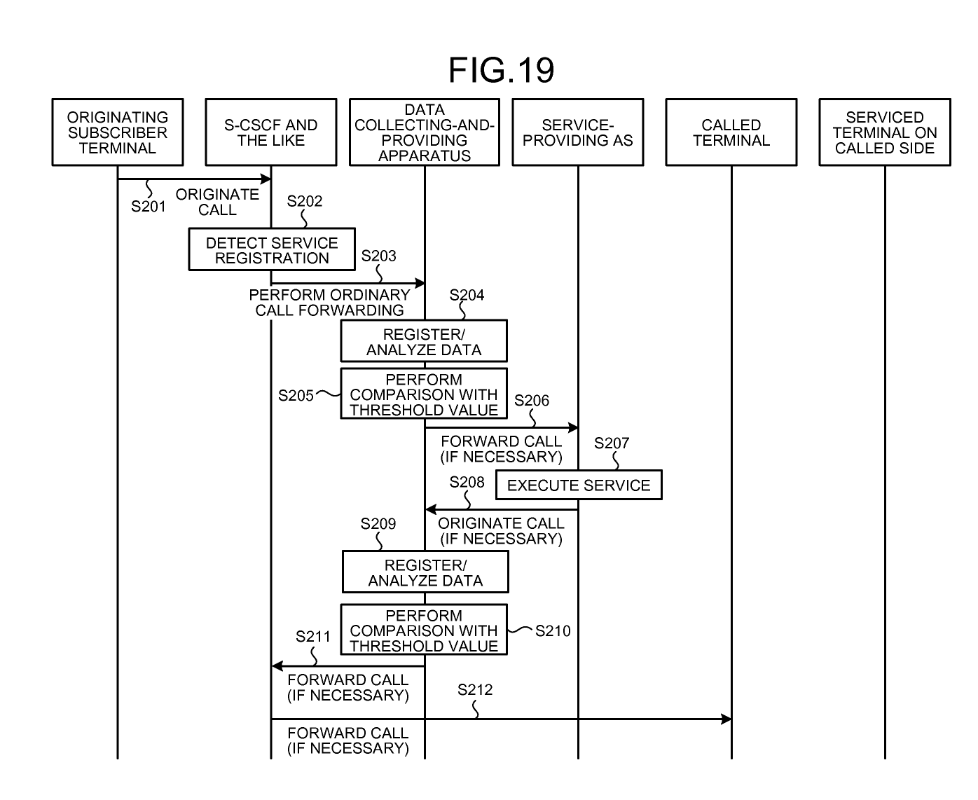

A statistical-data collecting process to be performed by the statistical-data collecting-and-providing apparatus 10 according to the first embodiment will be described with reference to FIG. 19. FIG. 19 is a sequence diagram illustrating the statistical-data collecting process to be performed by the statistical-data collecting-and-providing apparatus 10 according to the first embodiment.

As illustrated in FIG. 19, when the originating subscriber terminal originates an ordinary call (Step S201), the S-CSCF 30b and the like detect that this call matches a service registration criterion (for example, a criterion for a call forwarding service for “0120”) (Step S202), and forward the call to the data collecting-and-providing apparatus 10 (Step S203).

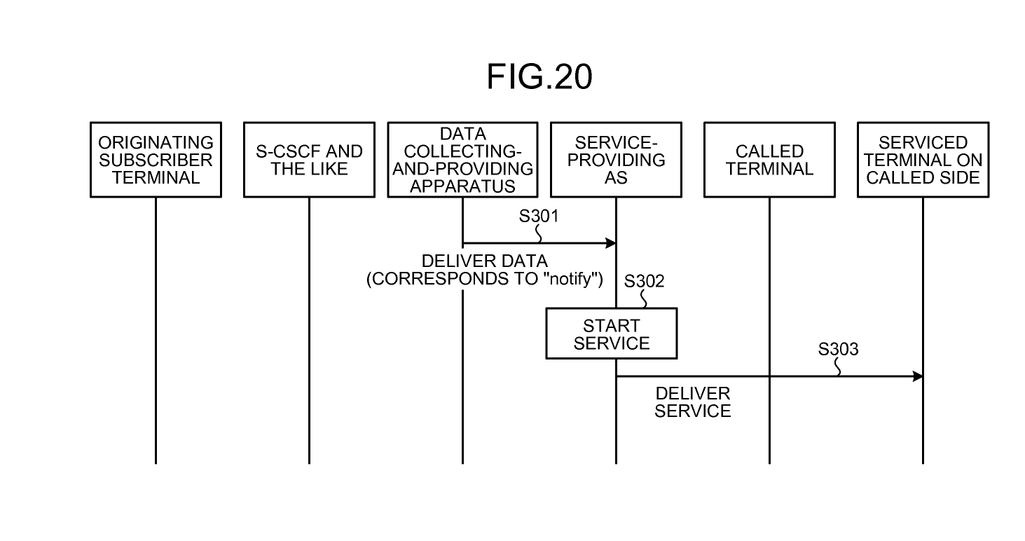

The data collecting-and-providing apparatus 10 performs data registration and analysis (Step S204). Thereafter, the data collecting-and-providing apparatus 10 collects and records necessary statistical data and determines whether the statistical data has matched a criterion (in the example of FIG. 19, whether the number of calls has exceeded a threshold value) for delivery to the service-providing AS 60 (Step S205). The process to be performed when the statistical data has matched the delivery criterion will be described later with reference to FIG. 20.

Subsequently, if it is necessary (for example, in a case of the call forwarding service for “0120”), the data collecting-and-providing apparatus 10 forwards the call to the service-providing AS 60 (Step S206). When the call has been forwarded, the service-providing AS 60 handles the call appropriately according to the service content (call forwarding service) (Step S207), creates a new call, and transmits the call to the data collecting-and-providing apparatus 10 (Step S208).

The data collecting-and-providing apparatus 10 performs data registration and analysis of the new call (Step S209), collects and records necessary statistical data (Step S210), and forwards the call to the S-CSCF 30b (Step S211). Thereafter, the S-CSCF 30b forwards the call to a called terminal as required (Step S212).

Statistical-Data Delivery Process Performed by Statistical-Data Collecting-and-Providing Apparatus

A statistical-data collecting-and-providing process to be performed by the statistical-data collecting-and-providing apparatus 10 according to the first embodiment will be described with reference to FIG. 20. FIG. 20 is a sequence diagram illustrating the statistical-data collecting-and-providing process to be performed by the statistical-data collecting-and-providing apparatus 10 according to the first embodiment. The process discussed below is performed when counted statistical data has matched the criterion (in the example of FIG. 19, as to whether the number of calls has exceeded the threshold value) for delivery to the service-providing AS 60.

As illustrated in FIG. 20, when statistical data has matched the criterion (in the example of FIG. 20, as to whether the number of calls has exceeded the threshold value) for delivery to the service-providing AS 60, the statistical-data collecting-and-providing apparatus 10 delivers the statistical data to the service-providing AS 60 (Step S301). The service-providing AS 60 starts service (Step S302) and delivers service that makes use of the statistical data to a serviced terminal on called side.

### Advantage of the First Embodiment

As discussed above, the statistical-data collecting-and-providing apparatus 10 delivers to a notification destination only data that is necessary for the notification destination only by making settings rather than modifying an operation system, thereby allowing reduction in load on the notification destination and operation management cost involved in service delivery.

### [b] Second Embodiment

While an embodiment of the present invention has been described, the present invention is not limited thereto but can be variously embodied. Hence, as a second embodiment, another embodiment according to the present embodiment will be described below.

(1) System Configuration and the Like

Each structural element of each of the illustrated units is functional conceptual one, and is not necessarily required to have such a physical configuration as illustrated. Specifically, specific modes of distribution and integration of the units are not limited to those illustrated in the drawings, and all or some of them can be functionally or physically distributed or integrated in an arbitrary unit according to various load, usage, and the like. For example, the message control unit 13b and the forwarding-message processing unit 13c can be integrated together. All or an arbitrary part of each processing function to be carried out by each unit can be implemented by a central processing unit (CPU) and a computer program to be analyzed and executed by the CPU, or implemented by means of hard-wired logic.

All or some of processes having been described above as processes to be automatically performed in the present embodiment can be performed manually, or all or some of processes having been described above as processes to be manually performed can be performed automatically by using a known method. In addition, the process procedures, the control procedures, the specific names, information including the various data and parameters described above or illustrated in the drawings can be arbitrarily changed unless otherwise specified.

(2) Computer Program

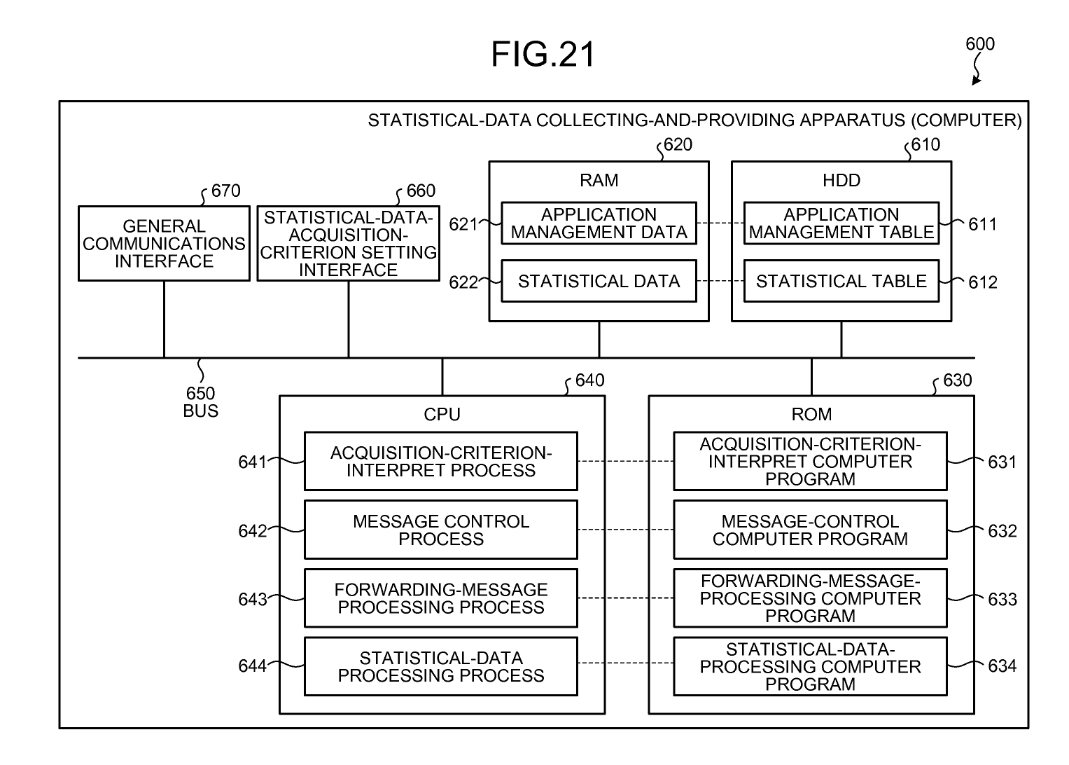

The processes described in the embodiment above can be implemented by causing a computer to execute a computer program prepared in advance. An example of a computer that executes a computer program that has a similar function with that of the embodiment discussed above will be described with reference to FIG. 21. FIG. 21 is a schematic diagram illustrating a computer that executes a statistical-data collecting-and-providing computer program.

As illustrated in FIG. 21, a computer 600 as the statistical-data collecting-and-providing computer program is constructed by connecting an hard disk drive (HDD) 610, random access memory (RAM) 620, read only memory (ROM) 630, a CPU 640, the statistical-data-acquisition-criterion setting interface 11, and the general communications interface 12 with a bus 650.

The statistical-data collecting-and-providing computer program; more specifically, an acquisition-criterion-interpret computer program 631, a message-control computer program 632, a forwarding-message processing computer program 633, and a statistical-data-processing computer program 634, that provides a similar function with that of the first embodiment is stored in the ROM 630 in advance as illustrated in FIG. 21. The computer programs 631 to 634 can be integrated or distributed as required as in the case of the structural elements of the statistical-data collecting-and-providing apparatus illustrated in FIG. 3.

The CPU 640 reads out the computer programs 631 to 634 from the ROM 630 and executes the same, thereby causing the computer programs 631 to 634 to function as the acquisition-criterion interpret process 641, the message control process 642, the forwarding-message processing process 643, and the statistical-data processing process 644 as illustrated in FIG. 21. The acquisition-criterion interpret process 641, the message control process 642, the forwarding-message processing process 643, and the statistical-data processing process 644 correspond to the acquisition-criterion interpret unit 13a, the message control unit 13b, the forwarding-message processing unit 13c, and the statistical-data processing unit 13d, which are illustrated in FIG. 3, respectively.

The HDD 610 includes an application management table 611 and an application management table 612 as illustrated in FIG. 21. The application management table 611 and the application management table 612 correspond to the application-management storage unit 14a and the statistical-data storage unit 14b, which are illustrated in FIG. 3, respectively. The CPU 640 performs, in addition to registering data in the application management table 611 and the application management table 612, storing in the RAM 620 application management data 621 and application management data 622 read out from the application management table 611 and the application management table 612 and data management based on the application management data 621 and the application management data 622 stored in the RAM 620.

According to an embodiment, only necessary data is delivered to a notification destination only by making settings rather than modifying an operation system. This can bring about reduction in load on the notification destination and operation management cost involved in service delivery.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable storage medium storing a computer program for collecting statistical data relating to communications and delivering the statistical data, the computer program causing a computer to execute an operation, the operation comprising:
receiving setting of a statistical-data acquisition criterion and setting of a notification destination which is a destination of statistical data delivery;
collecting the statistical data based on the received statistical-data acquisition criterion; and
delivering the collected statistical data to the notification destination.

2. The computer readable storage medium according to claim 1, wherein the receiving includes receiving, as the setting of the statistical-data acquisition criterion, at least any one of a message type, a part of the statistical data, identification data being a part of the statistical data, and data about accuracy with which the statistical data is to be acquired.

3. The computer readable storage medium according to claim 1, wherein
the receiving includes receiving setting of a criterion for statistical-data transmission to the notification destination in addition to the setting of the statistical-data acquisition criterion and the setting of the notification destination which is the destination of the statistical data delivery, and
the delivering includes delivering the collected statistical data to the received notification destination when the criterion for the statistical-data transmission to the received notification destination is satisfied.

4. The computer readable storage medium according to claim 1, wherein
the receiving includes receiving setting of a notification content to be delivered to the notification destination in addition to the setting of the statistical-data acquisition criterion and the setting of the notification destination which is the destination of the statistical data delivery, and
the delivering includes
creating a notification message by using the statistical data based on the received notification content; and
delivering the notification message to the notification destination.

5. A statistical-data collecting-and-delivery apparatus for collecting statistical data relating to communications and delivering the statistical data, the statistical-data collecting-and-delivery apparatus comprising:
a statistical-data-acquisition-setting receiving unit that receives setting of a statistical-data acquisition criterion and setting of a notification destination which is a destination of statistical data delivery;
a statistical-data collecting unit that collects the statistical data based on the statistical-data acquisition criterion received by the statistical-data-acquisition-setting receiving unit; and
a statistical-data delivering unit that delivers the statistical data collected by the statistical-data collecting unit to the notification destination received by the statistical-data-acquisition-setting receiving unit.

6. A method for collecting statistical data relating to communications and delivering the statistical data, the method comprising:
receiving setting of a statistical-data acquisition criterion and setting of a notification destination which is a destination of statistical data delivery;
collecting the statistical data based on the received statistical-data acquisition criterion; and
delivering the collected statistical data to the notification destination.
